(19) United States
(12) Patent Application Publication
(10) Pub. No.: US 2019/0236700 A1
(43) Pub. Date: Aug. 1, 2019

(54) STRATEGY LEG PRICE CALCULATION FOR INTERNAL MARKET FILLS

(71) Applicant: FIDESSA TRADING UK LIMITED, London (GB)

(72) Inventors: Yuriy Shterk, Cos Cob, CT (US); Davit Harutyunyan, Hinsdale, IL (US)

(73) Assignee: FIDESSA TRADING UK LIMITED, London (GB)

(21) Appl. No.: 16/262,141

(22) Filed: Jan. 30, 2019

Related U.S. Application Data
(60) Provisional application No. 62/623,649, filed on Jan. 30, 2018.

(51) Int. Cl. G06Q 40/04; G06Q 40/06

(52) U.S. Cl. CPC G06Q 40/04; G06Q 40/06

(57) ABSTRACT

An internal market system for determining strategy leg prices and leg quantities based on a defined strategy parameter, thus allowing for the matching of standard strategies or pre-defined strategies. An application platform derives strategy leg prices and leg quantities based on a strategy head price, a reference exchange price of individual legs, leg price ratio, and number of legs. As a result, whenever two strategy orders are crossed in an internal market system, a leg trade transaction is generated with prices and quantities that correspond to head strategy order trades. The internal market trade transactions are available to upstream processes for consumption within, for example, an order management system platform. Transactions are also reported to downstream processes for consumption by back-office and middle-office solutions for reporting and allocation purposes.

### CROSS-REFERENCE TO RELATED APPLICATIONS

This application is related to U.S. Provisional Application Ser. No. 62/623,649 filed Jan. 30, 2018 and entitled “STRATEGY LEG PRICE CALCULATION FOR INTERNAL MARKET FILLS,” which is incorporated herein by reference in its entirety and from which priority is claimed.

### BACKGROUND

Traders engaged in the trading of financial instruments can utilize software products that provide various graphical user interfaces to display market price data, execute orders, and monitor status of different market conditions. Market instruments can include anything that can be traded in some quantity for a particular price. For example, a market instrument can be goods or financial products (e.g., stocks, bonds, futures, currency, commodities, or other financial instruments). Market instruments can be “real” and listed on an exchange or “synthetic,” such as a combination of real products.

Electronic trading of market instruments has been embraced as the means for buying and selling instruments in various market exchanges throughout the world. Traders can communicate with host computers of the market exchanges or other intermediary host computers coupled with the exchanges via personal computer or mobile device. Electronic trading allows for the display of information regarding market instruments received from the host computer which can impact the decision making process of the trader with regard to placing orders.

Furthermore, principle trading firms oftentimes utilize internal market (IM) solutions for intercompany position transfers, thus allowing firms to cross orders off of an exchange. Internal market solutions act as a matching engine where buy and sell orders are crossed when certain conditions are met. Typically, internal market's support the matching of orders for outright instruments as well as standard strategies or pre-defined strategies. The matching of outright orders is straightforward in that price and quantity ratios are 1:1 and no legs or underlying contracts are involved; however, these conventional techniques do not apply to the matching of standard strategies or pre-defined strategies (sometimes referred to as exchange traded strategies), due to their more complex nature. Specifically, these strategies or techniques never existed for futures or options.

Accordingly, there is a need for a system which includes techniques for the matching of standard strategies or pre-defined strategies. Specifically, there is a need for a system which matches standard strategies or pre-defined strategies for any strategy for an exchange listed derivative (including futures and options).

### SUMMARY

The present disclosure generally relates to an internal market system for determining strategy leg prices and leg quantities based on a defined strategy parameter. Moreover, the subject matter of the present disclosure allows for the matching of standard strategies or pre-defined strategies.

In one embodiment, a method for strategy crossing is disclosed. The method includes (a) determining a liquidity for each of a plurality of legs for the strategy; (b) selecting a least liquid leg of the plurality of legs, where the least liquid leg has the lowest amount of activity per trading day based on the determining of (a); (c) determining a current market price for the least liquid leg; (d) repeating (c) for each leg of the plurality of legs until a most liquid leg is determined; and (e) calculating a price of the most liquid leg by applying market prices of the less liquid legs and a strategy price associated with the strategy.

In another embodiment, a computer system for strategy crossing is disclosed. The computer system includes a processor and a memory. The memory stores instructions that, when executed by the processor, cause the computer system to (a) determine a liquidity for each of a plurality of legs for the strategy; (b) select a least liquid leg of the plurality of legs, where the least liquid leg has the lowest amount of activity per trading day based on the determining of (a); (c) determine a current market price for the least liquid leg; (d) repeat (c) for each leg of the plurality of legs until a most liquid leg is determined; and (e) calculate a price of the most liquid leg by applying market prices of the less liquid legs and a strategy price associated with the strategy.

In another embodiment, a non-transitory computer-readable medium is disclosed. The non-transitory computer-readable medium stores instructions that, when executed by a processor, cause a computer system to strategy cross, by performing the steps of (a) determining a liquidity for each of a plurality of legs for the strategy; (b) selecting a least liquid leg of the plurality of legs, where the least liquid leg has the lowest amount of activity per trading day based on the determining of (a); (c) determining a current market price for the least liquid leg; (d) repeating (c) for each leg of the plurality of legs until a most liquid leg is determined; and (e) calculating a price of the most liquid leg by applying market prices of the less liquid legs and a strategy price associated with the strategy.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, and may admit to other equally effective embodiments.

FIG. 1 illustrates an exemplary chart listing various market states and corresponding descriptions in accordance with an embodiment of the disclosed subject matter.

FIG. 2 illustrates an exemplary chart listing various instrument states and corresponding descriptions in accordance with an embodiment of the disclosed subject matter.

FIG. 3 schematically illustrates an internal market grid filtered by instrument (internal market FIM code) and/or primary exchange code in accordance with an embodiment of the disclosed subject matter.

FIG. 4 schematically illustrates operations of a method for strategy crossing in accordance with an embodiment of the disclosed subject matter.

FIG. 5 illustrates a computer system configured for providing an application for strategy crossing according to one embodiment described herein.

### DETAILED DESCRIPTION

Certain exemplary and non-limiting embodiments of the disclosed subject matter will be described below with reference to the figures for the purposes of illustration and not limitation. It should be apparent, however, to those skilled in the art that many more modifications besides those described herein are possible without departing from the concepts of the disclosed subject matter.

In one aspect of the present disclosure a system for order matching is disclosed. The system can comprise one or more computing devices that can include one or more processors configured with software components to generate an interactive tool displayable to users. The system of the disclosed subject matter can further comprise a network for providing communication and connectability to the one or more computing devices. The system of the disclosed subject matter can further comprise one or more servers, which can provide storage and access capabilities for storing information to be delivered to users and, additionally or alternatively, information received from users. In certain embodiments, the system can include an internal market component for supporting derivative order flow to provide matching capabilities for orders on futures and options (F&O) markets outside of a primary market. The internal market can support derivatives order flow in order to match and/or cross orders internally, such as off of a primary exchange.

By way of example, a futures and options internal market instrument model can implement the following types of instruments: outright futures, options on futures, exchange listed (futures) spreads, and/or inter-commodity (exchange listed) spreads. In some examples, derivatives exchanges and instruments may have specific qualities, such as variable tick size, zero and negative price, fractional price, and/or reduced tick spreads, each of which the internal market is capable of interpreting and supporting.

In some embodiments, the internal market subscribes to a primary exchange's reference and/or market data for FIM coding on an original order. This subscription captures trading sessions, instrument static data, and/or market conditions. The operation of the internal market and any matching decisions are made based on the obtained information.

In some embodiments, the internal market reflects an exchange's market state and/or instrument state for operational purposes. By way of example, trading hours of the internal market can mimic each exchange's trading hours. Furthermore, market states and/or instrument states can be supported for each of the supported exchanges.

Example: Market States

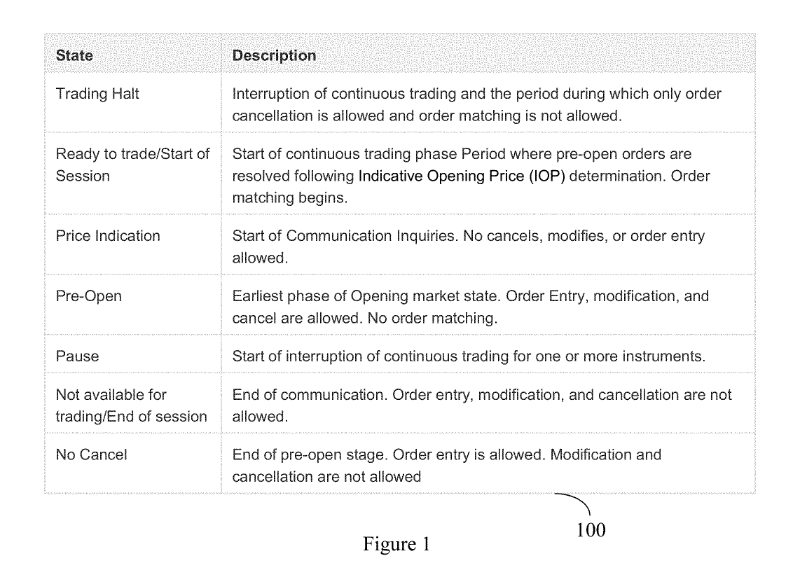

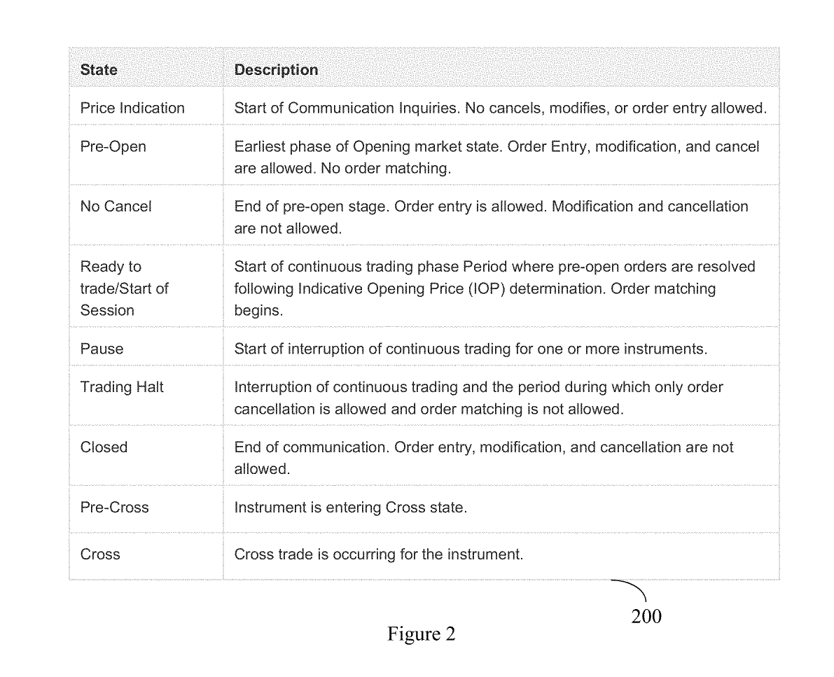

FIG. 1 illustrates a chart 100 listing various example market states and corresponding descriptions. FIG. 2 illustrates a chart 200 listing various instrument states and corresponding descriptions. In certain embodiments, the internal market may perform a crossing action in, for example, the “ready to trade/start of session” states shown in both FIG. 1 and FIG. 2.

Orders are entered manually and/or received electronically and subsequently entered into the internal market. In certain embodiments, the following fields are entered for internal market order entry: order side, order type, order price, quantity, instrument code, client, account, and/or TIF (Time-In-Force).

Each crossed order in the internal market generates and sends a fill report for the instrument in the original order. An owner of the original order may subsequently receive a fill for each order.

Matching may occur against price and/or time priority. The internal market supports limit orders for matching perspectives. From a perspective of the internal market, standard strategies or pre-defined strategies are handled in the same manner as outright orders, and matching is performed on a strategy level. In some embodiments, once two strategy orders are matched, the internal market and/or the SOR captures a market price of back legs at the time of execution and/or calculates a fill price of other legs based on a spreads differential and the back leg's price. In certain embodiments, a fill report for strategies includes the fill of root strategy order as well as fill prices of legs.

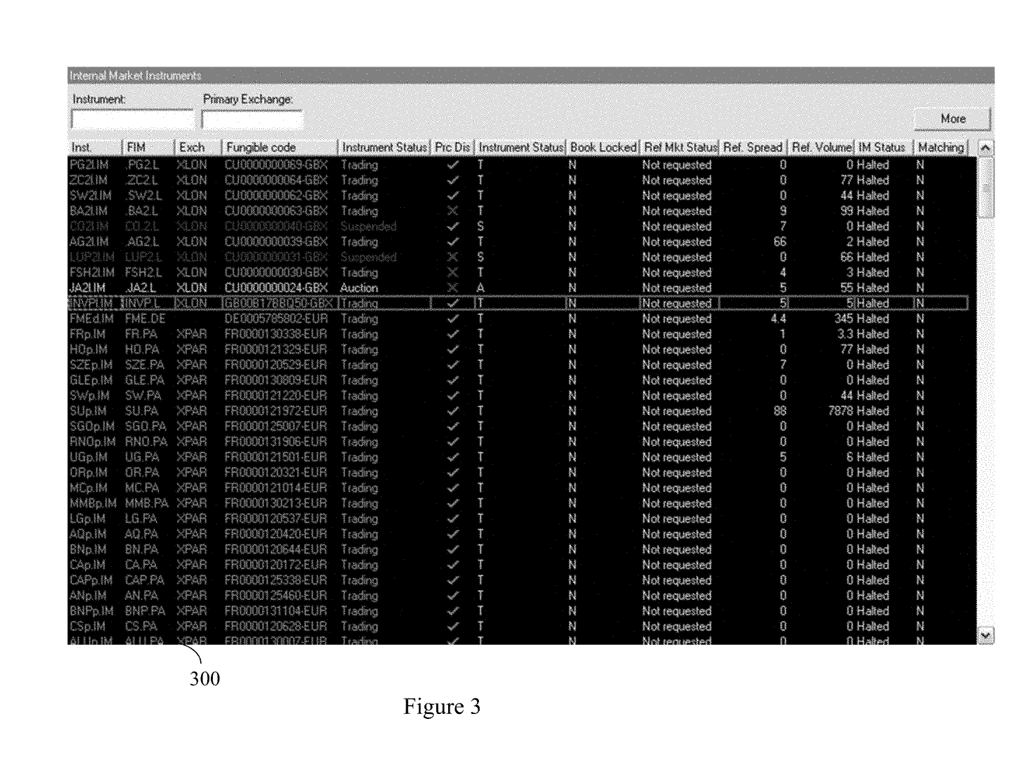

The internal market further provides for permissioned users to view configured instruments in the internal market via the use of existing internal market grids. Moreover, in certain embodiments, the internal market grid can be filtered by instrument (internal market FIM code) and/or primary exchange code, as illustrated by the screenshot 300 of FIG. 3. For certain futures and options contracts expiry fields are also included and/or added.

In some embodiments, as it relates to a futures and options internal market, a requirement is set to have a single firm-wide internal market instance with multiple counterparties wherein orders from different counterparties can be crossed. As such, any two orders with matching instruments are considered eligible for crossing regardless of account/counterparty as long as both are routed to the internal market. Crosses occur on the top of a primary exchange market. In some embodiments, crossing at a price that is better than a market price is permitted; however, crossing on a price that is worse than a market price is not permitted. In certain embodiments trader level permissions exist which make a trader eligible for sending order flow to the internal market.

In certain embodiments, the internal market reports an additional flag for executed internal orders to a back office. This flag is used for downstream integration with a customer's back office to identify when an order has been crossed internally.

Futures and options oftentimes have special characteristics regarding static instrument data. These special characteristics include, but are not limited to, fraction pricing, overnight trading sessions, and/or reduced tick size contracts. Each special characteristic is taken into account within the futures and options internal market.

Examples of Supported Strategies—

The internal market supports numerous legged exchange strategies. Said strategies are crossed as outright orders. Also, leg level fills are reported in fill reports. This approach works across various strategy types.

Calendar Strategies (Two Legs of 1:1 Ratio)—

A calendar spread includes two instruments of the same product with differing maturity months. Variation may exist in calendar spreads based on each individual product. In some embodiments, each calendar spread variation is designated through the use of a different spread type code.

### Calendar Strategy:

### Example: Buy the Spread

Buy 1—December 2015—corn
Sell 1—March 2016—corn

### Example: Sell the Spread

Sell 1—December 2015—corn
Buy 1—March 2016—corn

### Security Description Example: Selling 1 ZCZ5-ZCH6

Butterfly Strategies (Three Legs of 1:2:1 Ratio)—

A butterfly includes three instruments within the same product group each having equally distributed maturity months (e.g., M8-U8-Z8). Buy one butterfly is equivalent to buying one of the closer maturity leg, sell two of the next maturity leg, and buy 1 of the furthest maturity leg (e.g., a +1:−2:+1 ratio).

### Butterfly

### Example:

### Construction: Buy1Exp1 Sell2Exp2 Buy1Exp3

### Security Description Example: ZC:BFM5-U5-Z5

### Example: Buy the Butterfly

Buy 1—June 2015—corn and
Sell 2—September 2015—corn and
Buy 1—December 2015—corn

### Example: Sell the Butterfly

Sell 1—June 2015—corn and
Buy 2—September 2015—corn and
Sell 1—December 2015 corn

Commodities Inter-Commodity (Three Legs of 11:9:10)—

An inter-commodity spread includes two or more futures instruments of different products. In some embodiments, tick instruments are of the same value.

By way of example only, a soybean crush spread (soybeans+10/bean oil−9/bean meal−11) represents the price differential between the raw soybean product and the yield of its two processed products (i.e., the processing margin). The fixed ratio per leg represents the amount of soybean oil and soybean mean that can be obtained from the give amount of raw soybeans.

### Construction: Sell11Exp1Com1 Sell9Exp1Com2 Buy10Exp1Com3

### Security Description Example: SOM: SI N4-N4-N4

### Example: Buy the Spread

Buy 11—July—Soybean meal

### Buy 9—July—Soybean oil

### Sell 10—July—Soybeans

### Example: Sell the Spread:

Sell 11—July—Soybean meal

### Sell 9—July—Soybean oil

### Buy 10—July—Soybeans

The internal crossing of buy orders and sell orders in the derivative space allows for the internalization of flow. Additionally, the present disclosure relates to the crossing of products or strategy types for standard strategies or pre-defined strategies, and specifically allows for the matching of standard strategies or pre-defined strategies for any strategy for exchange listed derivatives (including futures and options).

The present disclosure also relates to the determination for calculating a price for each leg that is to be reported back with each corresponding strategy order. By way of example only, for an intra-commodity spread (i.e., those spreads in which each leg belongs to the same product), the current market price of the least liquid leg is utilized, and a determination is made as to where the public market is trading on each least liquid leg. This determination is continued for each subsequent least liquid leg until a point is reached in which one leg is undetermined. At such time, a mathematical algorithm is applied which is associated with the strategy.

By way of further example, an inter-commodity spread (those spreads of strategies trading across different products) takes a similar approach as discussed above with relation to an intra-commodity spread, but also includes a validation step to ensure the final price is also a price that can actually be traded on a market. As such, the goal is receive a reasonable price at which the market could have traded such that the leg prices are close to or in-line with where the market could have traded on a public exchange.

The logic utilized to calculate leg trade prices from strategy trades matched in the internal market are further discussed herein. Furthermore, internal market software is used herein for derivatives, and most notably strategies. The internal market is utilized to match opposing orders internally before going to market.

Functional aspects for calculating leg trades include the calculation and publication of trades for outright futures when a strategy trade is matched in the internal market. This enables the booking and managing of positions at the outright level. Leg trades are calculated and published with each strategy trade that occurs in the internal market.

Non-functional aspects include the immediate calculation and publication of leg trades after the trade strategy matches in the internal market. Furthermore, all leg trades are published against the outright instrument in the primary market, although not necessarily the internal market instrument. Additionally, when calculating leg trades, the reference prices from the primary market are used as input because these give the most accurate reflection of the current market. In the event that a leg price cannot be determined immediately after the strategy trade, then leg trades will be generated and published immediately along with an “unknown price” flag. Such designation enables a downstream user to select these flagged trades and assign prices to them.

All internal market trades can be distinguishable from on-market trades, thus ensuring that the internal market trades do not follow the same clearing process. In certain embodiments, all calculated price trades can have their price rounded up or down to the nearest price divisible by the relevant tick size. The rounding may ensure that the calculated trade has a valid price for the instrument. In some embodiments, for variable tick scale band instruments, a band can be established to invoke by determining and/or evaluating the calculated price of the trade.

Examples of asset classes that can have calculated leg trades generated include, by way of example only, (1) futures calendar spreads; and (2) futures butterfly spreads, among others.

In some embodiments, at least one trade is created for each of the leg instruments when a strategy trade occurs. To ensure that all leg price trades are representative of the original strategy trade price, the strategy trade price is used along with all leg prices except one. This remaining leg will have a trade price calculated based upon various rules outlined herein to ensure that all leg price trades combined with their ratio sum up to the original strategy trade. As discussed herein, a calculation of the leg prices can be based on the type of strategy. In some embodiments, all reference prices can be sourced from the instrument on its primary market rather than on the internal market. Furthermore, in some embodiments, all calculated leg trades can be created against the primary market instrument rather than against the internal market instrument.

For futures calendar and inter-commodity spreads, formula (1), shown below, illustrates the calculation for determining a leg trade price:

$${tradepric}_{lc} = \frac{{price}_{s} - ( {price}_{lr} * {ratio}_{lr} )}{{ratio}_{lc}} \qquad Formula ( 1 )$$

where:

| | |
|---|---|
| priceₛ | The price of the strategy trade that triggered the calculation. |
| priceₗᵣ | The price of the Reference Leg. |
| ratioₗᵣ | The ratio of Reference Leg. |
| tradeprice_{lc} | The Calculated Leg Price trade for the remaining leg. This |
| | should be rounded to the nearest TICK_SIZE for the |
| | instrument. |
| ratio_{lc} | The ratio of leg having a price calculated for it. |

The Reference Leg is the last traded price of the least liquid leg (i.e., the leg with the lowest non-zero trade count today). If both legs have the same non-zero trade count today then the last traded price of the back month is used as the Reference Price. For inter-commodity spreads, the second leg is used.

Otherwise, in certain embodiments, the previous settlement price of the back month is used as the Reference Price if available. Otherwise, for inter-commodity spreads, the second leg may be used.

Example: Calendar Spread Trade

To illustrate the above by way of example, assume the Three Month Sterling Calendar Spread Jun16 Jun17 has a trade at a price of 1.5 with its two legs currently as follows:

| FIM | Description | Ratio | m_VWAP_NUM | m_MID | m_LAST_SETTLEMENT |
|---|---|---|---|---|---|
| L_FM6.LO | Three | 1 | 5 | 99.40 | 99.41 |
| | Month | | | | |
| | Sterling | | | | |
| | Jun16 | | | | |
| L_FM7.LO | Three | −1 | 2 | 99.26 | 99.27 |
| | Month | | | | |
| | Sterling | | | | |
| | Jun17 | | | | |

Thus, given the far month (Jun17) is the least liquid instrument and has traded today, the Last Traded Price price along with the spread's trade price are used to calculate a trade price for the near month (Jun16):

$$L\_SM6M7 \cdot LO = 1.5$$

$$L\_FM6 \cdot LO = \frac{1.5 - ( 99.26 * - 1 )}{1} = 100.76$$

$$L\_FM7 \cdot LO = 99.26$$

For futures butterfly spreads, the formula for calculating a leg trade price is illustrated below by formula (2):

$${tradeprice}_{lc} = \frac{{price}_{s} - ( {price}_{lr 1} * {ratio}_{lr 1} ) - ( {price}_{lr 2} * {ratio}_{lr 2} )}{{ratio}_{lc}} \qquad Formula ( 2 )$$

where:

| | |
|---|---|
| priceₛ | The price of the strategy trade that triggered the calculation. |
| priceₗᵣ₁ | The Leg Reference Price 1 value. |
| ratioₗᵣ₁ | The ratio of leg used to provide the Leg Reference Price 1 |
| | in the strategy. |
| priceₗᵣ₂ | The Leg Reference Price 2 value. |
| ratioₗᵣ₂ | The ratio of leg used to provide the Leg Reference Price 2 |
| | in the strategy. |
| tradeprice_{lc} | The Calculated Leg Price trade for the remaining leg. This |
| | should be rounded to the nearest TICK_SIZE for the |
| | instrument. |
| ratio_{lc} | The ratio of leg having a price calculated for it. |

Where the Reference Legs are the last traded prices of the least liquid legs (i.e., the legs with the lowest non-zero trade counts today. If all legs have the same non-zero trade count today then the last traded price of the back two months is used as the Reference Prices. Otherwise, the previous settlement prices of the back two months are used as the Reference Prices, if both are available.

Example: Calendar Spread Trade

To illustrate the above by way of example, assume the Three Month Euro (Euribor) Butterfly Sep16 Mar17 Sep17 (I_S92141404.LO) has a trade price of −0.015 with its three legs as follows:

| FIM | Description | Ratio | m_VWAP_NUM | m_MID | m_LAST_SETTLEMENT |
|---|---|---|---|---|---|
| I_FU6.LO | Three Month Euro | 1 | 2 | 100.27 | 100.275 |
| | (Euribor) Sep16 | | | | |
| I_FH7.LO | Three Month Euro | −2 | 5 | 100.29 | 100.29 |
| | (Euribor) Mar17 | | | | |
| I_FU7.LO | Three Month Euro | 1 | 2 | 100.29 | 100.29 |
| | (Euribor) Sep17 | | | | |

Given the near and far months (Sep16 and Sep17) are the least liquid legs, their price along with the strategy's trade price is used to calculate a trade price for the mid-month (Mar17). By way of continued example:

$$I\_S92141404 \cdot LO = - 0.015$$

$$I\_FU6 \cdot LO = 100.27$$

$$I\_FH7 \cdot LO = \frac{- 0.015 - ( 100.27 * 1 ) - ( 100.29 * 1 )}{- 2} = 100.2875 \\ I\_FU7 \cdot LO = 100.29$$

Implied Crush Spreads: In some embodiments leg trade prices for implied crush spreads trading on an internal market are also calculated. The legs of implied crush spreads have different pricing units and tick sizes to the strategy instrument, as illustrated in Table 1 below.

TABLE 1

| | | | Native | | |
|---|---|---|---|---|---|
| Leg | | | Tick | | |
| Number | | Instrument Name | Size | Price Factor | Price |
| 1 | + | Soybean Meal | 0.1 | 2.2 ($/short | 337.2 |
| | | Futures | | ton) | |
| 2 | + | Soybean Oil Futures | 0.01 | 11 (¢/lb) | TBC |
| 3 | − | Soybean Futures | 0.25 | 1 ($/bushel) | 995.25 |
| Strategy | = | Soybean Crush | 0.25 | 1 ($/bushel) | 98.75 |

Price Factor is a coefficient applied to legs in order to normalize the units of price into the same units as the strategy instruments price.

Example: Given the Prices Shown in the Table Above, Calculating the Price of the Oil Leg Using the Current Formula is as Follows:

$$OilLegPrice = \frac{\begin{matrix}( CrushStrategyPrice + BeanLegPrice ) - \\ ( MealLegPrice \times MealLegPriceFactory )\end{matrix}}{OilLegPriceFactor}$$

$$OilLegPrice = \frac{( 98.75 + 995.25 ) - ( 337.2 \times 2.2 )}{11}$$

$$OilLegPrice = 32.0145454545$$

This price is off-tick. Under current logic, OilLegPrice would be rounded to 32.01 (Assuming a buy order). However, if OilLegPrice is rounded and the leg prices are used to calculate the price of the crush spread:

CrushPrice=(OilLegPrice×OilLegPriceFactor)+(MealLegPrice×MealLegPriceFactor)−BeanLegPrice

CrushPrice=(32.01×11)+(337.2×2.2)−995.25

CrushPrice=98.7

This price is in turn off-tick and therefore the price of the legs do not add up to a valid strategy price. As such, the bean leg's tick size and price factor are the same as the crush spread's. Therefore, if the Meal and Oil legs are rounded to a multiple of the crush spread's tick size, the Bean leg's price can be calculated using the above formula and will be exactly on-tick. The following algorithm is used to calculate leg trade prices that are always on-tick: (1) Take the price of the Meal leg and Oil leg from the market; and (2) Round these prices to a variable called leg tick size override. Leg tick size override is applied to a leg price instead of the leg instrument's native tick size. Leg tick size override is defined as the lowest common factor of (a) the leg instrument's native tick size multiplied by the leg's price factor; (b) the strategy instrument's tick size; and (3) calculate the price of the Bean leg using the new rounded Meal leg and Oil leg prices.

| | Native Leg | Leg Tick Size | | |
|---|---|---|---|---|
| Instrument Name | Tick Size | Override | Price Factor | Price |
| Soybean Meal | 0.1 | 2.5 | 2.2 ($/short | 337.2 |
| Futures | | | ton) | |
| Soybean Oil | 0.01 | 0.25 | 11 (¢/lb) | 32.01 |
| Futures | | | | |
| Soybean Futures | 0.25 | 0.0 | 1 ($/bushel) | TBC |
| Soybean Crush | 0.25 | N/A | 1 ($/bushel) | 98.75 |

By way of continued example, to calculate the price of the Bean leg from the table above, MealLegPrice=337.2, which gets ticked up to 337.5 (assuming a buy order) and OilLegPrice=32.01, which gets ticked up to 32.25 (assuming a buy order).

BeanLegPrice=(OilLegPrice×OilLegPriceFactor)+(MealLegPrice×MealLegPriceFactor)−CrushPrice

BeanLegPrice=(337.5×2.2)+(32.25×11)−98.75

BeanLegPrice=998.5

Leg Tick Size Override: Leg tick size override behaves exactly like a tick size and will override the leg instrument's native tick size. It is defined differently for each leg and can be set configurably. Applying leg tick size override to each leg allows that the prices of all of the legs and the price of the strategy as a whole will be on-tick. Leg tick size override is defined for each leg as the lowest common factor of (1) the leg instrument's tick size×The leg's price factor; and (2) the strategy instrument's tick size. In some embodiments, this data is not supplied by tickerplant, and therefore is supplied to the internal market via the IMFDM_STRATEGY_PRICE_CONFIG SystemDefinition item. In certain embodiments, this is the same configuration mechanism used to supply leg price factors to the internal market. The leg tick size override values for implied crush spreads are tabulated below in Table 2:

TABLE 2

| Leg Number | Instrument Name | Leg Tick Size Override |
|---|---|---|
| 1 | Soybean Meal Futures | 2.5 |
| 2 | Soybean Oil Futures | 0.25 |
| 3 | Soybean Futures | 0.0 |
| Strategy | Soybean Crush | 0.0 |

In some embodiments, once two strategy orders are sent to the internal market for matching and once all matching criteria are met, the internal market can match head strategy orders. In certain embodiments, the matching of head strategy orders is similar to that of the outright pricing perspective (i.e., based on, for example, price and quantity). However, in order to complete the matching process, leg prices and quantities also require determination. Furthermore, said leg prices and/or said quantities correspond to trade records also require creation, and, in some embodiments, require downstream and/or upstream reporting. Reporting can include sending leg information, for example leg price. In some embodiments, the reporting can simulate a message as if the message were sent from an exchange.

In some embodiments, the disclosed internal market system, utilizing Formulas 1 and 2 above, derives strategy leg prices and leg quantities based on a determined strategy head price, reference exchange price for individual legs, leg price ratio, and/or number of legs. As such, whenever two strategy orders are crossed in the internal market, a leg trade transaction is generated. The leg trade transaction includes prices and quantities which correspond to the head strategy order trades.

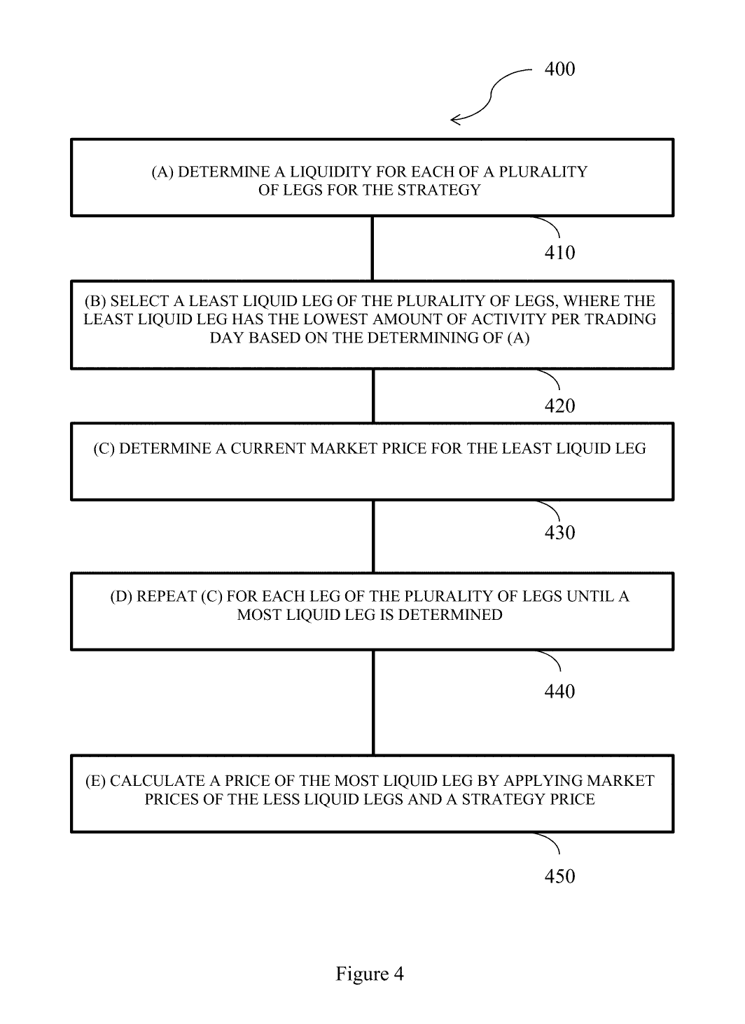

FIG. 4 schematically illustrates operations of a method 400 for strategy crossing, according to one embodiment described herein. The method 400 generally relates to embodiments for the matching of standard strategies or pre-defined strategies for any strategy. Specifically, in some embodiments, the method 400 relates to exchange listed derivatives, such as futures and/or options. At operation 410, a liquidity for each leg of a plurality of legs is determined for the particular strategy. The determination can be made using the operations and methods described above. In some embodiments, the determining includes analyzing a volume of each leg traded on a contract. At operation 420, a least liquid leg of the plurality of legs is selected. In some embodiments, the least liquid leg is characterized in that the least liquid leg has the lowest amount of activity per trading day of each of the plurality of legs, as determined by operation 410. At operation 430, a current market price is determined for the least liquid leg. At operation 440, a current market price is determined for each of the plurality of legs of operation 430 until a most liquid leg is determined. At operation 450, a price of the most liquid led is calculated. The calculating applies market prices of each of the less liquid legs of the plurality of legs. Furthermore, a strategy price associated with the strategy is also calculated.

In some embodiments, the method 400 also includes an operation for preparing a fill message. The fill message includes at least a price of the strategy. In certain embodiments, the fill message can include a fill price for each leg. The some embodiments, the method 400 also includes distributing the fill message upstream. In some embodiments, the method 400 also includes crossing a buy order and sell order without reporting to an exchange.

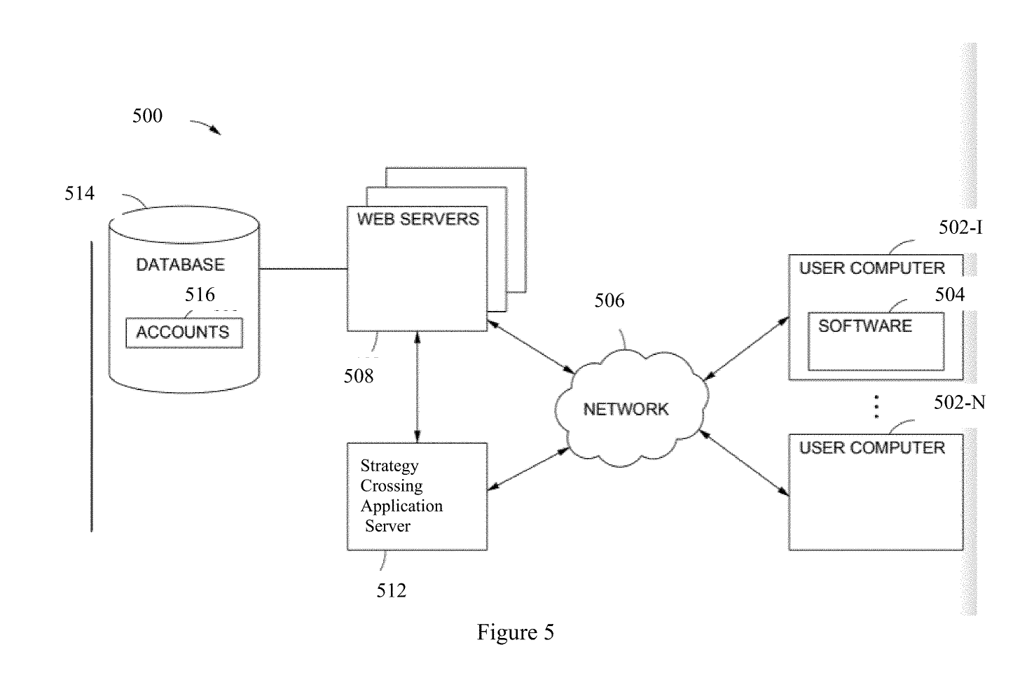

FIG. 5 illustrates a computing system 500 configured to provide an application for strategy crossing in which embodiments of the disclosure may be practiced. As shown, the computing system 500 may include a plurality of web servers 508, a strategy crossing application server 502, and a plurality of user computers (i.e., mobile/wireless devices) 502 (only two of which are shown for clarity), each connected to a communications network 506 (for example, the Internet). The web servers 508 may communicate with the database 514 via a local connection (for example, a Storage Area Network (SAN) or Network Attached Storage (NAS)) or over the Internet (for example, a cloud based storage service). The web servers 508 are configured to either directly access data included in the database 514 or to interface with a database manager that is configured to manage data included within the database 514. An account 516 is a data object that stores data associated with a user, such as the user's email address, password, contact information, billing information, and the like.

Each user computer 502 may include conventional components of a computing device, for example, a processor, system memory, a hard disk drive, a battery, input devices such as a mouse and a keyboard, and/or output devices such as a monitor or graphical user interface, and/or a combination input/output device such as a touchscreen which not only receives input but also displays output. Each web server 508 and the strategy crossing application server 512 may include a processor and a system memory (not shown), and may be configured to manage content stored in database 514 using, for example, relational database software and/or a file system. The web servers 508 may be programmed to communicate with one another, user computers 502, and the strategy crossing application server using a network protocol such as, for example, the TCP/IP protocol. The strategy crossing application server 512 may communicate directly with the user computers 502 through the communications network 506. The user computers 502 are programmed to execute software 504, such as web browser programs and other software applications, and access web pages and/or applications managed by web servers 508 by specifying a uniform resource locator (URL) that directs to web servers 508.

In the embodiments described herein, users are respectively operating the user computers 502 that are connected to the web servers 508 over, for example, the communications network 506. Web pages may be displayed to a user via the user computers 502. The web pages are transmitted from the web servers 508 to the user's computer 502 and processed by the web browser program stored in that user's computer 502 for display through a display device and/or a graphical user interface in communication with the user's computer 502.

Benefits of the present disclosure include that the internal market system mimics the logic of native exchanges specific to strategy order matching. Furthermore, the internal market trade transactions are available to upstream processes for consumption within an order management software platform. Moreover, the internal market trade transaction are also available to downstream processes for consumption by back-office and/or middle-office solutions for, by way of example only, reporting and allocation purposes.

Additional benefits include the ability to receive strategy fill price(s) without leg fill pricing. Also, the present disclosure provides for the opportunity to cross buy orders and sell orders without reporting to an exchange. The need to find a match manually, e.g., by voice, is also eliminated.

Benefits of internal markets include allowing firms to match orders outside of an exchange, thus reducing and/or eliminating costs such as execution costs. Internal markets also allow for the hiding of liquidity from the rest of the market which slippage and/or information leakage is also reduced and/or eliminated.

Additional benefits of the present disclosure include improving the speed, accuracy, and usability of the computer and trader transactions, especially in the context of computerized trading. The embodiments of the present disclosure cannot be performed with pen and paper or mentally, and, as such, the present disclosure significantly improves trading which can be performed in real time. The present disclosure provides improved, unconventional techniques for employing, configuring, determining, calculating, selecting, using, analyzing, displaying, and the like with respect to strategy crossing.

Although one or more embodiments have been described herein in some detail for clarity of understanding, it should be recognized that certain changes and modifications can be made without departing from the spirit of the disclosure. The embodiments described herein can employ various computer-implemented operations involving data stored in computer systems. Furthermore, the embodiments described herein employ various computer-implemented operations which can be adapted to be part of a computer system, the cloud, etc. For example, these operations can require physical manipulation of physical quantities—usually, though not necessarily, these quantities can take the form of electrical or magnetic signals, where they or representations of them are capable of being stored, transferred, combined, compared, or otherwise manipulated. Further, such manipulations are often referred to in terms, such as producing, yielding, identifying, determining, comparing, receiving, storing, calculating, or generating. Any operations described herein that form part of one or more embodiments of the disclosure can be useful machine operations. In addition, one or more embodiments of the disclosure also relate to a device or an apparatus for performing these operations. The apparatus can be specially constructed for specific required purposes, or it can be a general purpose computer selectively activated or configured by a computer program stored in the computer. In particular, various general purpose machines can be used with computer programs written in accordance with the teachings herein, or it can be more convenient to construct a more specialized apparatus to perform the required operations.

The embodiments described herein can be practiced with other computer system configurations including hand-held devices, microprocessor systems, microprocessor-based or programmable consumer electronics, minicomputers, mainframe computers, and the like.

One or more embodiments of the present disclosure can be implemented as one or more computer programs or as one or more computer program modules embodied in one or more computer readable media. The term computer readable medium refers to any data storage device that can store data which can thereafter be input to a computer system—computer readable media can be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Disc), a CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present disclosure have been described in some detail for clarity of understanding, it will be apparent that certain changes and modifications can be made within the scope of the claims. Accordingly, the described embodiments are to be considered as illustrative and not restrictive, and the scope of the claims is not to be limited to details given herein, but can be modified within the scope and equivalents of the claims. In the claims, elements do not imply any particular order of operation, unless explicitly stated in the claims.

Many variations, modifications, additions, and improvements can be made. Plural instances can be provided for components, operations or structures described herein as a single instance. Boundaries between various components, operations and data stores are somewhat arbitrary, and particular operations are illustrated in the context of specific illustrative configurations. Other allocations of functionality are envisioned and can fall within the scope of the disclosure(s). In general, structures and functionality presented as separate components in exemplary configurations can be implemented as a combined structure or component. Similarly, structures and functionality presented as a single component can be implemented as separate components. It will be apparent to those skilled in the art that various modifications and variations can be made in the method and system of the disclosed subject matter without departing from the spirit or scope of the disclosed subject matter. These and other variations, modifications, additions, and improvements can fall within the scope of the appended claim(s) and their equivalents.

In one aspect of the present disclosure, the internal market system and/or the strategy crossing system can comprise one or more computing devices that can include one or more processors configured with software components to generate an interactive tool displayable to users. The internal market system and/or the strategy crossing system of the disclosed subject matter can further comprise a network for providing communication and connectability to the one or more computing devices. The internal market system and/or the strategy crossing system of the disclosed subject matter can further comprise one or more servers, which can provide storage and access capabilities for storing information to be delivered to users and, additionally or alternatively, information received from users. The one or more processors of the computing device can be configured to receive and aggregate data corresponding to one or more market instruments on, for example, one or more exchanges via the network, wherein the market data can be stored by the one or more servers.

In accordance with an exemplary and non-limiting embodiment, the computing device can be configured to create and/or match standard strategies or pre-defined strategies, as described above as well as output said strategy order match or other internal market transactions to the computing device. The standard strategies, pre-defined strategies, or other internal market transactions can be generated via the interactive tool displayable to users, such as for example, a graphical user interface (GUI) or other interactive desktop tool or application. For example, the interactive tool can comprise a graphical user interface comprising interactive windows having graphical control elements such as drop-down menus, dialog boxes, buttons, toolbars, and the like, allowing users to submit information to the computer system. In some embodiments, the GUI may be a touch screen based graphical user interface.

The techniques disclosed herein can support the matching of standard strategies or pre-defined strategies, determine and/or report leg prices and/or quantities to downstream and upstream processes, and further provide for the crossing of strategies. Additionally, it should be apparent to one of ordinary skill in the art that the unconventional techniques disclosed herein can be combined with other market analytics and/or internal market tools.

As described above in connection with certain embodiments, certain components, e.g., the user computers 502 and the Strategy Crossing Application Server 512 can include a computer or computers, processor, network, mobile device, cluster, or other hardware to perform various functions. Moreover, certain elements of the disclosed subject matter can be embodied in computer readable code which can be stored on computer readable media and which when executed can cause a processor to perform certain functions described herein. In these embodiments, the computer and/or other hardware play a significant role in permitting the system and method for displaying market depth information. For example, the presence of the computers, processors, memory, storage, and networking hardware provides the ability to display market depth information in a more efficient manner. Moreover, the display of market information, strategy crossing, and/or the determining of strategy leg prices and/or leg quantities based on a defined strategy parameter to allow for the matching of standard strategies or pre-defined strategies, cannot be accomplished with pen or paper, as such information is received over a network in electronic form.

Additionally, as described above in connection with certain embodiments, certain components can communicate with certain other components, for example via a network, e.g., the internet. To the extent not expressly stated above, the disclosed subject matter is intended to encompass both sides of any transaction, including transmitting and receiving. One of ordinary skill in the art will readily understand that with regard to the features described above, if one component transmits, sends, or otherwise makes available to another component, the other component will receive or acquire, whether expressly stated or not.

The presently disclosed subject matter is not to be limited in scope by the specific embodiments herein. Indeed, various modifications of the disclosed subject matter in addition to those described herein will become apparent to those skilled in the art from the foregoing description and the accompanying figures. Such modifications are intended to fall within the scope of the appended claims.

What is claimed is:

1. A method for strategy crossing, comprising:
(a) determining a liquidity for each of a plurality of legs for the strategy;
(b) selecting a least liquid leg of the plurality of legs, where the least liquid leg has the lowest amount of activity per trading day based on the determining of (a);
(c) determining a current market price for the least liquid leg;
(d) repeating (c) for each leg of the plurality of legs until a most liquid leg is determined; and
(e) calculating a price of the most liquid leg by applying market prices of the less liquid legs and a strategy price associated with the strategy.

2. The method of claim 1, further comprising preparing a fill message, wherein the fill message includes at least a fill price of the strategy.

3. The method of claim 2, wherein the fill message further includes a fill price of each leg.

4. The method of claim 2, further comprising distributing the fill message upstream.

5. The method of claim 1, wherein the determining the liquidity for each of the plurality of legs includes analyzing a volume of each leg traded on a contract.

6. The method of claim 1, further comprising crossing a buy order and a sell order without reporting to an exchange.

7. The method of claim 6, further comprising matching at least one of the buy order or the sell order with an order outside of an exchange.

8. A computer system for strategy crossing, comprising:
a processor; and
a memory storing instructions that, when executed by the processor, cause the computer system to:
(a) determine a liquidity for each of a plurality of legs for the strategy;
(b) select a least liquid leg of the plurality of legs, where the least liquid leg has the lowest amount of activity per trading day based on the determining of (a);
(c) determine a current market price for the least liquid leg;
(d) repeat (c) for each leg of the plurality of legs until a most liquid leg is determined; and
(e) calculate a price of the most liquid leg by applying market prices of the less liquid legs and a strategy price associated with the strategy.

9. The computer system of claim 8, further comprising preparing a fill message, wherein the fill message includes at least a fill price of the strategy.

10. The computer system of claim 9, wherein the fill message further includes a fill price of each leg.

11. The computer system of claim 9, further comprising distributing the fill message upstream.

12. The computer system of claim 8, wherein the determining the liquidity for each of the plurality of legs includes analyzing a volume of each leg traded on a contract.

13. The computer system of claim 8, further comprising crossing a buy order and a sell order without reporting to an exchange.

14. A non-transitory computer-readable medium storing instructions that, when executed by a processor, cause a computer system to strategy cross, by performing the steps of:
(a) determining a liquidity for each of a plurality of legs for the strategy;
(b) selecting a least liquid leg of the plurality of legs, where the least liquid leg has the lowest amount of activity per trading day based on the determining of (a);
(c) determining a current market price for the least liquid leg;
(d) repeating (c) for each leg of the plurality of legs until a most liquid leg is determined; and
(e) calculating a price of the most liquid leg by applying market prices of the less liquid legs and a strategy price associated with the strategy.

15. The non-transitory computer-readable medium of claim 14, further comprising preparing a fill message, wherein the fill message includes at least a fill price of the strategy.

16. The non-transitory computer-readable medium of claim 15, wherein the fill message further includes a fill price of each leg.

17. The non-transitory computer-readable medium of claim 15, further comprising distributing the fill message upstream.

18. The non-transitory computer-readable medium of claim 14, wherein the determining the liquidity for each of the plurality of legs includes analyzing a volume of each leg traded on a contract.

19. The non-transitory computer-readable medium of claim 14, further comprising crossing a buy order and a sell order without reporting to an exchange.

20. The non-transitory computer-readable medium of claim 19, further comprising matching at least one of the buy order or the sell order with an order outside of an exchange.
